(19) United States
(12) Patent Application Publication
(10) Pub. No.: US 2013/0242003 A1
(43) Pub. Date: Sep. 19, 2013

(54) LIQUID EJECTION HEAD AND METHOD OF MANUFACTURING LIQUID EJECTION HEAD

(71) Applicants: Toshio Suzuki, Sagamihara-shi (JP); Ryota Kashu, Kawasaki-shi (JP)

(72) Inventors: Toshio Suzuki, Sagamihara-shi (JP); Ryota Kashu, Kawasaki-shi (JP)

(73) Assignee: CANON KABUSHIKI KAISHA, Tokyo (JP)

(21) Appl. No.: 13/989,505

(22) PCT Filed: Dec. 7, 2011
(86) PCT No.: PCT/JP2011/006849

§ 371 Date: May 24, 2013

(30) Foreign Application Priority Data
Dec. 24, 2010 (JP) 2010-288006
Nov. 10, 2011 (JP) 2011-246454

(51) Int. Cl. B41J 2/14

(52) U.S. Cl. CPC B41J 2/14201
USPC 347/68; 156/60

(57) ABSTRACT

A liquid ejection head includes a plurality of ejection orifices which eject a liquid, a plurality of pressure chambers which store the liquid ejected from the ejection orifices and eject the liquid from the ejection orifices in accordance with expansion and contraction of an inner wall of the pressure chambers, and a plurality of recess portions which are formed around the pressure chambers, wherein a piezoelectric member is present between at least one of the recess portions and the pressure chambers.

### TECHNICAL FIELD

The present invention relates to a liquid ejection head that ejects a liquid and a method of manufacturing the same.

### BACKGROUND ART

In general, a liquid ejection head which ejects ink is mounted on an ink jet recording apparatus which records an image on a recording medium by ejecting ink thereto. As a mechanism which causes the liquid ejection head to eject ink, there is a known mechanism which uses a pressure chamber of which the volume can be shrunk by a piezoelectric element. In this mechanism, when the pressure chamber is shrunk by the deformation of the piezoelectric element to which a voltage is applied, the ink inside the pressure chamber is ejected from an ejection orifice which is formed in one end of the pressure chamber. As a liquid ejection head with such a mechanism, there is known a so-called shear mode type in which one or two inner wall surfaces of a pressure chamber are formed of a piezoelectric element and the pressure chamber is contracted by shearing the piezoelectric element through the application of a voltage thereto.

In an ink jet apparatus for industrial purpose, there is a demand for the use of a highly viscous liquid. In order to eject the highly viscous liquid, the liquid ejection head needs to have a larger ejection force. In order to meet such a demand, there is proposed a liquid ejection head which is called a so-called gourd type in which a pressure chamber is formed of a cylindrical piezoelectric member with a circular or rectangular cross-sectional shape. In the gourd type liquid ejection head, the pressure chamber can be expanded or contracted in such a manner that the piezoelectric member is uniformly deformed with respect to the center of the pressure chamber in the inward-outward direction (the radial direction). In the gourd type liquid ejection head, since all wall surfaces of the pressure chamber are deformed and the deformation contributes to the force of ejecting ink, it is possible to obtain a larger liquid ejecting force compared to the shear mode type in which one or two wall surfaces are formed of the piezoelectric element.

In the gourd type liquid ejection head, there is a need to arrange plural ejection orifices with higher density in order to obtain higher resolution. With such arrangement, there is a need to arrange the pressure chambers respectively corresponding to the ejection orifices with higher density. PTL 1 discloses a method of manufacturing a new gourd type liquid ejection head in which pressure chambers can be arranged with high density.

In the manufacturing method disclosed in PTL 1, first, plural grooves which extend in the same direction are formed in each of plurality piezoelectric plates. Subsequently, the plural piezoelectric plates are stacked with the directions of the grooves matched, and are cut in the direction perpendicular to the directions of the grooves. In the cut piezoelectric plate, the groove portion forms the inner wall surface of the pressure chamber. Subsequently, in order to separate the respective pressure chambers, the piezoelectric member present between the pressure chambers is removed up to a predetermined depth. The upper and lower portions of the piezoelectric plate with the completed pressure chambers are connected to a supply path plate, an ink pool plate, a printed circuit board, and a nozzle plate, thereby completely manufacturing the liquid ejection head. According to the manufacturing method disclosed in PTL 1, since the pressure chambers can be arranged in a matrix shape, the pressure chambers can be arranged with high density. Further, according to this manufacturing method, since the groove can be easily processed in the piezoelectric plate compared to the case of perforating the piezoelectric plate, it is considered that the pressure chamber can be formed with high precision.

In the liquid ejection head which is manufactured by the manufacturing method disclosed in PTL 1, the plural pressure chambers are arranged with a space interposed therebetween. For this reason, in particular, when the length (the height) of the pressure chamber is made to be long in order to eject a highly viscous liquid (in order to increase the force of ejecting a liquid), the rigidity of the liquid ejection head reduces. When the rigidity reduces, a liquid may not be ejected when the pressure chamber is folded.

### CITATION LIST

### Patent Literature

PTL 1: Japanese Patent Application Laid-Open No. 2007-168319

### SUMMARY OF INVENTION

A liquid ejection head includes a plurality of ejection orifices which eject a liquid, a plurality of pressure chambers which store the liquid ejected from the ejection orifices and eject the liquid from the ejection orifices in accordance with expansion and contraction of an inner wall of the pressure chambers, and a plurality of recess portions which are formed around the pressure chambers, wherein a piezoelectric member is present between at least one of the recess portions and the pressure chambers.

Further features of the present invention will become apparent from the following description of exemplary embodiments with reference to the attached drawings.

### BRIEF DESCRIPTION OF DRAWINGS

FIG. 1 is a perspective view showing the appearance of a liquid ejection head of a first embodiment of the invention.

FIG. 2A is view showing the respective surfaces of a piezoelectric block unit shown in FIG. 1.

FIG. 2B is view showing the respective surfaces of a piezoelectric block unit shown in FIG. 1.

FIG. 2C is view showing the respective surfaces of a piezoelectric block unit shown in FIG. 1.

FIG. 2D is view showing the respective surfaces of a piezoelectric block unit shown in FIG. 1.

FIG. 3A is perspective view illustrating a groove formation process.

FIG. 3B is perspective view illustrating a groove formation process.

FIG. 4A is perspective view illustrating a plating process.

FIG. 4B is perspective view illustrating a plating process.

FIG. 4C is perspective view illustrating a plating process.

FIG. 4D is perspective view illustrating a plating process.

FIG. 5 is a perspective view illustrating a polarization treatment process.

FIG. 6 is a perspective view illustrating a stacking process.

FIG. 7A is cross-sectional view showing a simulation model of a liquid ejection head.

FIG. 7B is cross-sectional view showing a simulation model of a liquid ejection head.

FIG. 7C is cross-sectional view showing a simulation model of a liquid ejection head.

FIG. 8A is graph respectively showing a simulation voltage waveform and a simulation result.

FIG. 8B is graph respectively showing a simulation voltage waveform and a simulation result.

FIGS. 9A and 9B are diagrams illustrating a liquid ejection head of a second embodiment of the invention.

FIGS. 9C and 9D are diagrams illustrating a liquid ejection head of a second embodiment of the invention.

FIG. 10 is a front view showing the structure of a main part of a liquid ejection head of a third embodiment of the invention.

FIG. 11 is a perspective view showing the appearance of a liquid ejection head of a fourth embodiment of the invention.

FIG. 12 is a perspective view showing the appearance of a liquid ejection head of a fifth embodiment of the invention.

FIG. 13 is a perspective view showing the appearance of a liquid ejection head of a sixth embodiment of the invention.

FIG. 14 is a view when seen from A of FIG. 13.

FIG. 15 is a perspective view showing the appearance of a liquid ejection head of a seventh embodiment of the invention.

### DESCRIPTION OF EMBODIMENTS

Hereinafter, an example of embodiments of a liquid ejection head and a method of manufacturing the same of the invention will be described by referring to the drawings.

Furthermore, in first to fifth embodiments, a type of simultaneously driving all pressure chambers will be shown in order to simplify the description of the electrode interconnection.

### First Embodiment

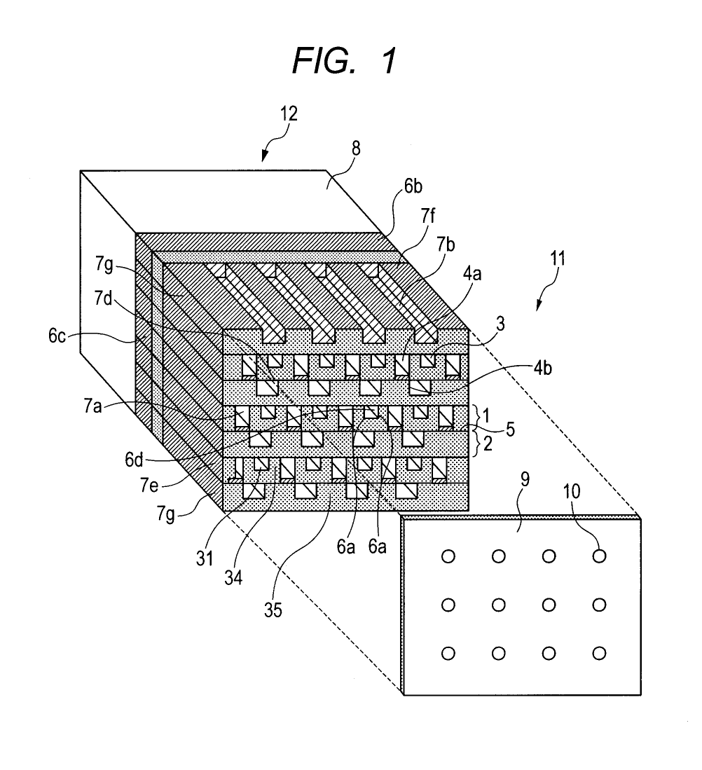

First, the structure of a liquid ejection head showing a first embodiment of the invention will be described. FIG. 1 is a perspective view showing the appearance of the liquid ejection head of the first embodiment of the invention.

As shown in FIG. 1, a liquid ejection head 12 of the embodiment includes an ink pool plate 8, a piezoelectric block unit 11, and a nozzle plate 9. The nozzle plate 9 is bonded to the front surface of the piezoelectric block unit 11. Furthermore, in FIG. 1, the piezoelectric block unit and the nozzle plate 9 are separated so that the structure of the piezoelectric block unit 11 is easily understood. The nozzle plate 9 is provided with plural ejection orifices 10 each being formed of a circular through-hole, and the ejection orifices 10 are arranged two-dimensionally with a predetermined interval therebetween. The ink pool plate 8 is bonded to the rear surface of the piezoelectric block unit 11.

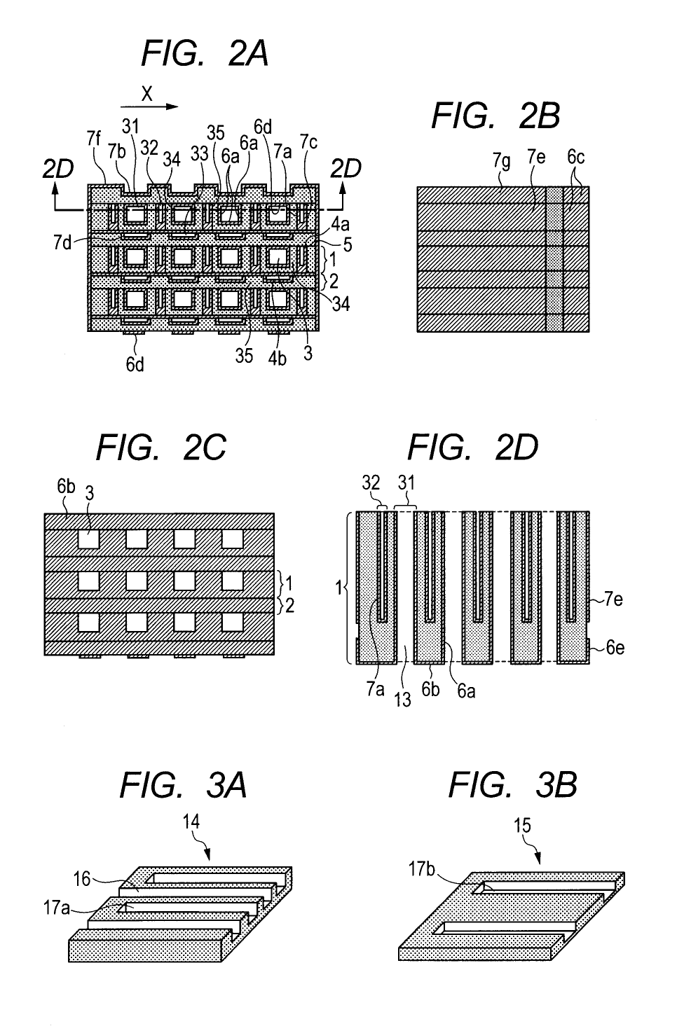

FIGS. 2A to 2D are views showing the respective surfaces of the piezoelectric block unit 11 shown in FIG. 1. FIG. 2A is a front view. FIG. 2B is a side view. FIG. 2C is a rear view. FIG. 2D is a cross-sectional view taken along the cutting line 2D-2D shown in FIG. 2A.

The piezoelectric block unit 11 is a layered unit in which a plate 1 (first plate) and a plate 2 (second plate) are alternately stacked with an adhesive layer 5 interposed therebetween. The plates 1 and 2 are also piezoelectric materials, and each plate 1 includes plural pressure chambers 3 which stores a liquid and plural recess portions 4a (first recess portions). The pressure chambers 3 and the recess portions 4a are separated from each other by a piezoelectric member 34. Further, the plate 2 is provided with plural recess portions 4b (second recess portions), and the respective recess portions 4b are separated from each other by a piezoelectric member 35.

Each of the pressure chambers 3 includes a square pressure chamber opening 31 and a square passageway 13 (refer to FIG. 2D). The pressure chamber opening 31 is formed in the front surface of the plate 1 so as to face (communicate with) the ejection orifice 10. The opening diameter of the pressure chamber opening 31 is slightly larger than the opening diameter of the ejection orifice 10. The passageway 13 extends from the pressure chamber opening 31 so as to penetrate the inside of the plate 1 (refer to FIG. 2D).

As shown in FIG. 2A, the pressure chamber opening 31 is arranged so that plural pressure chamber opening arrays in each of which plural pressure chambers are arranged in one surface of the plate 1 with an interval (a first interval) interposed therebetween in a first direction X are arranged in a second direction intersecting the first direction X with an interval (a second interval) interposed therebetween. As shown in FIG. 2A, the recess portions 4a have openings 32 which are arranged alternately with the pressure chamber openings 31 in the first direction X (refer to FIG. 2D), and extend inside the plate 1 from the openings 32 so as to be parallel to the pressure chambers 3. Further, as shown in FIG. 2A, the recess portions 4b have openings 33 which are arranged alternately with the pressure chamber openings 31 in the second direction, and extend inside the plate 2 from the openings 33 so as to be parallel to the pressure chambers 3.

As shown in FIG. 2A, three surfaces of the inner wall of the pressure chamber 3 are provided with a first electrode 6a. As shown in FIGS. 2C and 2D, the first electrode 6a is connected to an electrode 6b which is formed in the rear surface of the plate 1. As shown in FIG. 2D, the electrode 6b is connected to an electrode 6c which is formed in the side surface of the plate 1.

The inner wall surface (the inner wall side) formed of the plate 2 in the pressure chamber 3 is provided with a first electrode 6d, which is connected to the electrode 6a formed in the plate 1. In the plate 2, the electrode 6b is formed in the rear surface, the electrode 6c is formed in the side surface, and the electrode 6d is connected to the electrodes 6b and 6c.

As shown in FIG. 2D, the inner wall surface (the inner wall side) of the recess portion 4a is provided with a second electrode 7a. The second electrode 7a is connected to an electrode 7c which is formed in the lower portion of the opening 32 (refer to FIG. 2A). The electrode 7c is connected to an electrode 7d which is formed in the lower surface of the plate 1. As shown in FIG. 2B, the electrode 7d is connected to an electrode 7e which is formed in the side surface of the plate 1. Furthermore, in the side surface of the piezoelectric plate 1, the electrode 7e is disposed so as to be spaced from the electrode 6c.

The inner wall surface (the inner wall side) of the recess portion 4b is provided with a second electrode 7b. The polarity of the second electrode 7b is the same as the polarity of the second electrode 7a, and is different from the polarity of the first electrode 6a. The second electrode 7b is connected to an electrode 7f (refer to FIG. 1) formed in the top surface of the plate 2. The electrode 7f is connected to an electrode 7g which is formed in the side surface of the plate 2 (refer to FIG. 1).

In the plate 1 and the plate 2 with the above-described structure, piezoelectric members 34 and 35 are subjected to a polarization treatment in advance from the inner wall surface of the pressure chamber 3 to the inner wall surfaces of the recess portions 4a and the recess portions 4b. For this reason, when a positive voltage is applied to the first electrodes 6a and 6d formed in the inner wall surface of the pressure chamber 3 and the second electrode 7a formed in the inner wall surface of the recess portions 4a and the second electrodes 7b and 7d formed in the inner wall surface of the recess portions 4b are grounded, the pressure chamber 3 is contracted. Accordingly, an ink which is introduced from the ink pool plate 8 to the pressure chamber 3 is ejected from the ejection orifices 10 through the pressure chamber openings 31.

According to the liquid ejection head 12 of this embodiment, the interval between the pressure chambers 3 is formed of the recess portions 4a and 4b and the piezoelectric members 34 and 35. For this reason, it is possible to increase the rigidity of the pressure chamber compared to the structure in which a space is interposed between the pressure chambers.

Next, referring to FIGS. 3A to 3B, 4A to 4D, 5, and 6 the process of manufacturing the liquid ejection head 12 will be described. Furthermore, here, the process of manufacturing the piezoelectric block unit 11 will be described in detail.

FIGS. 3A and 3B are perspective views illustrating a groove formation process. As shown in FIG. 3A, in the groove formation process, plurality grooves 16 (first grooves) forming the inner wall surfaces of the respective pressure chambers 3 and plural grooves 17a (second grooves) forming the inner wall surfaces of the respective recess portions 4a are alternately formed in a piezoelectric material substrate 14 by dicing. The respective grooves 16 extend from one surface of the piezoelectric material substrate 14 to the opposite surface thereof, and one end of the grooves 16 forms the pressure chamber opening 31. The respective grooves 17a extend from one surface of the piezoelectric material substrate 14 so as to be parallel to the grooves 16, and are terminated inside the piezoelectric material substrate 14. Further, in the groove formation process, as shown in FIG. 3B, plural groove 17b (third grooves) forming the inner wall surfaces of the respective recess portions 4b are formed in the piezoelectric material substrate 15 by dicing. The respective grooves 17b extend from one surface of the piezoelectric material substrate 15 in one direction, and are terminated inside the piezoelectric material substrate 15. When the groove formation process is completed, a plating process is performed.

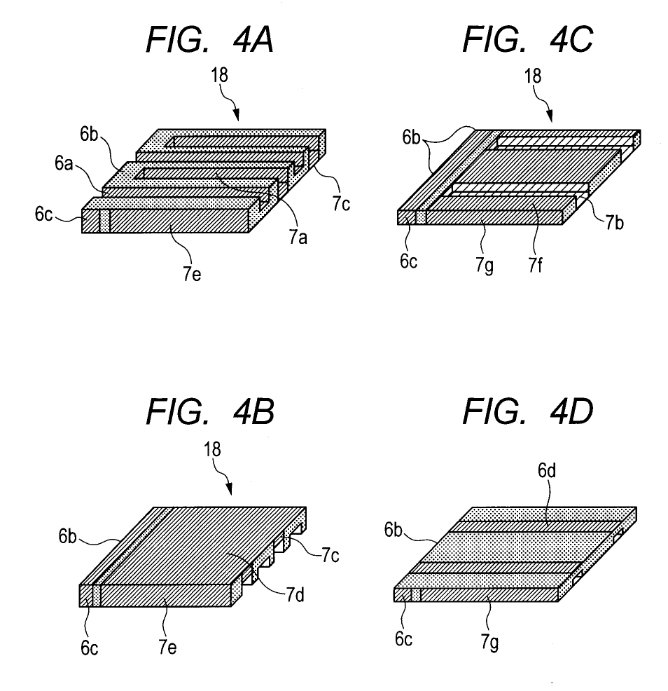

FIGS. 4A to 4D are perspective views illustrating the plating process. FIG. 4A is a perspective view showing the piezoelectric material substrate 14 from the front surface side, and FIG. 4B is a perspective view showing the piezoelectric material substrate 14 from the rear surface side. FIG. 4C is a perspective view showing the piezoelectric material substrate 15 from the front surface side, and FIG. 4D is a perspective view showing the piezoelectric material substrate 15 the rear surface side.

As shown in FIGS. 4A and 4B, in the plating process, selective plating 18 is performed on the front and rear surfaces of the piezoelectric material substrate 14. Accordingly, the first electrodes 6a, 6b, and 6c, the second electrode 7a, and the electrodes 7c to 7e which are described above are formed in the piezoelectric material substrate 14. Further, in the plating process, as shown in FIGS. 4C and 4D, selective plating 18 is also performed on the front and rear surfaces of the piezoelectric material substrate 15. Accordingly, the first electrodes 6d, 6b, and 6c, the second electrode 7b, the electrode 7f, and the electrode 7g are formed in the piezoelectric material substrate 15. When the plating process is completed, a polarization treatment process is performed so as to cause the piezoelectric block unit 11 to be such that the respective pressure chambers 3 are deformable to be contracted.

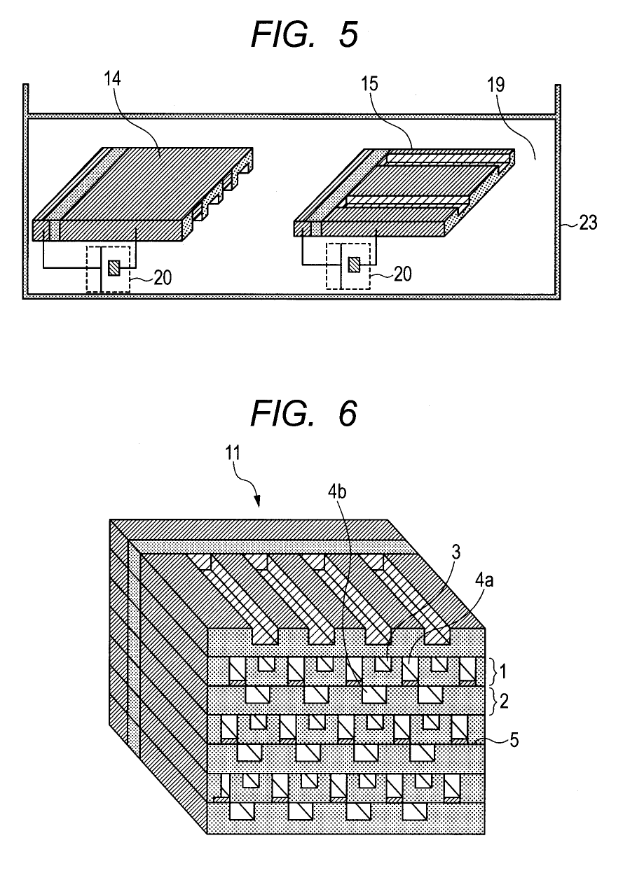

FIG. 5 is a perspective view illustrating the polarization treatment process. As shown in FIG. 5, in the polarization treatment process, a 200 degree Celsius silicon oil 19 is inserted into a container 23, and 2 kV/ram of an electric field is applied from a power supply 20 to the piezoelectric material substrates 14 and 15, so that the piezoelectric material substrates 14 and 15 are polarized. As a result, the plate 1 and the plate 2 are completely manufactured. When the polarization treatment process is completed, the stacking process is performed.

FIG. 6 is a perspective view illustrating the stacking process. As shown in FIG. 6, in the stacking process, plural plates 1 and plural plates 2 are alternately bonded to each other with an adhesive layer 5 interposed therebetween. Accordingly, the piezoelectric block unit 11 is completed. The nozzle plate 9 is bonded to the front surface of the completed piezoelectric block unit 11. Further, the ink pool plate 8 is bonded to the rear surface of the completed piezoelectric block unit 11. Accordingly, the liquid ejection head 12 is completed.

In the above-described manufacturing processes, the polarization treatment process is performed before the stacking process. This is because the adhesive used in the adhesive layer 5 requires heat resistance and electric-field resistance when the polarization treatment process is performed after the stacking process and the applicable adhesive is limited. In this embodiment, since the polarization treatment process is performed before the stacking process, it is possible to select a wide variety of adhesives which may be applied to the adhesive layer 5. Further, when the polarization treatment process is performed before the stacking process, since it is possible to perform the polarization treatment at the stage of a large substrate in the case where plural piezoelectric plates are produced from a single large substrate, this is advantageous for mass production.

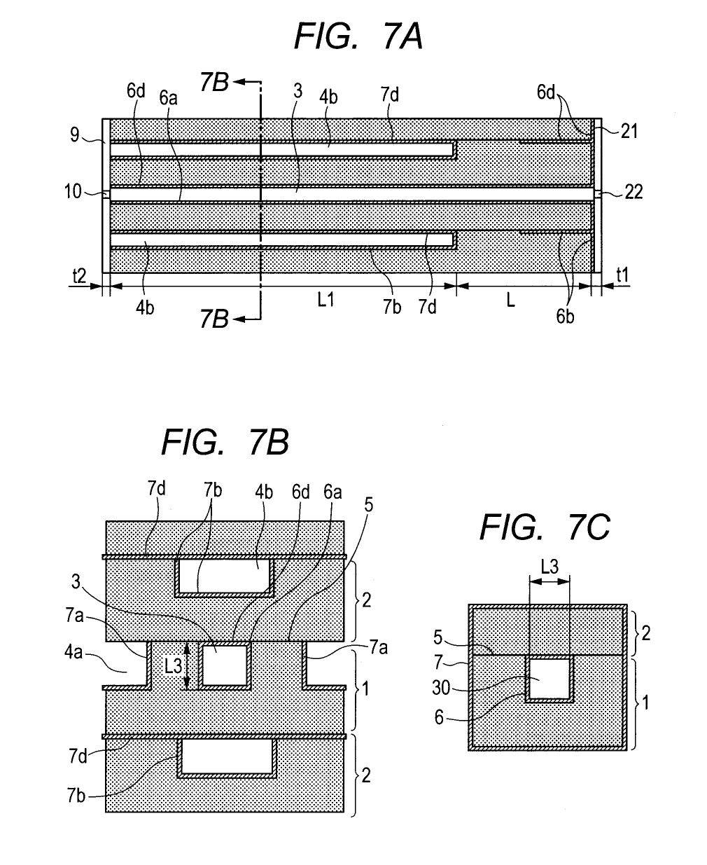

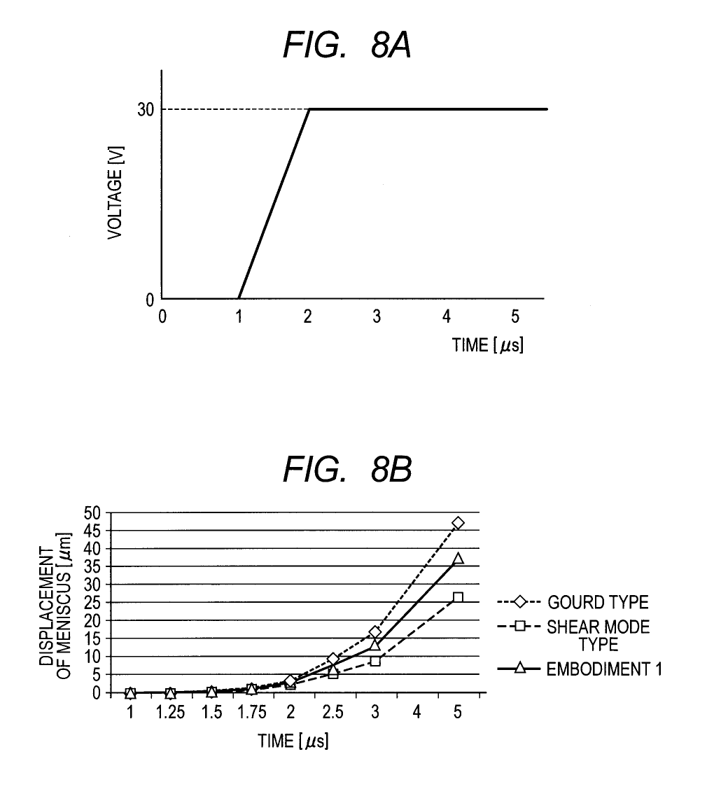

Next, a simulation model for comparing the liquid ejection head 12 of this embodiment and the liquid ejection head of the comparative example and the simulation result will be described by referring to FIGS. 7A to 7C, 8A, and 8B. Furthermore, here, as the liquid ejection head of the comparative example, a conventional gourd type liquid ejection head with a space interposed between the pressure chambers and a wall driving shear mode type liquid ejection head famous for the industrial liquid ejection head are used. Further, the structure calculation simulator manufactured by ANSYS, Inc. is used.

FIG. 7A is the longitudinal cross-section of the simulation model of the liquid ejection head 12 of this embodiment. FIG. 7B is a cross-sectional view taken along the cutting line of 7B-7B shown in FIG. 7A. FIG. 7C is a cross-sectional view of the pressure chamber of the gourd type liquid ejection head which is one of the comparative examples.

In the simulation model shown in FIGS. 7A and B, a length L1 of the driving portion which contracts the pressure chamber 3 is set to 6 mm, and the simulation model includes a base portion which is provided in rear of the driving portion and has a length L2 of 5 mm. Further, the simulation model includes a diaphragm plate 21 which is provided in rear of the driving portion, has a thickness t1 of 0.22 mm, and is formed of silicon. The diaphragm plate 21 is provided with a diaphragm 22 of which the width is set to 0.03 mm, the height is set to 0.2 mm, and the length is set to 0.22 mm. Furthermore, as the materials of the piezoelectric plates 1 and 2, lead zirconate titanate (PZT) is used. Further, the nozzle plate 9 is affixed to the front side of the driving portion, the nozzle plate having the ejection orifice 10 with a diameter of 0.02 mm and a thickness t2 of 0.02 mm and being formed of stainless steel (SUS).

The cross-sectional area of the pressure chamber 30 shown in FIG. 7C is the same as the cross-sectional area of the pressure chamber 3 shown in FIG. 7B. The cross-sectional shape of each of the pressure chambers 3 and 30 is a square of which each edge L3 is 0.12 mm. The pressure chamber 3 and the pressure chamber 30 are different from each other depending on whether the outer periphery is restrained.

Regarding the dimension of the simulation model of the shear mode type liquid ejection head, the cross-section of the pressure chamber was set so that the width was 0.1 mm and the height was 0.2 mm, and the thickness of the driving wall was set to 0.07 mm.

FIG. 8A shows the voltage waveform for contracting the simulation model of the respective pressure chambers of this embodiment and the comparative example. As shown in the waveform shown in FIG. 8A, in this simulation, a +30 V voltage was applied to the inner wall surfaces of the respective pressure chambers for 1 to 2 microseconds. The viscosity of ink was set to 40 mPa·s. FIG. 8B shows a graph in which the meniscus displacement representing a variation in liquid surface in a nozzle portion over time is plotted in the vertical axis. The graph in FIG. 8B shows that the force of ejecting ink becomes larger as the meniscus displacement becomes larger when compared at the same time.

In the simulation result shown in FIG. 8B, the force of ejecting ink of the liquid ejection head of this embodiment is higher than that of the shear mode type, although being inferior to the gourd type of the comparative example. For this reason, the liquid ejection head of this embodiment has an ejection performance enough for ejecting highly viscous ink.

### Second Embodiment

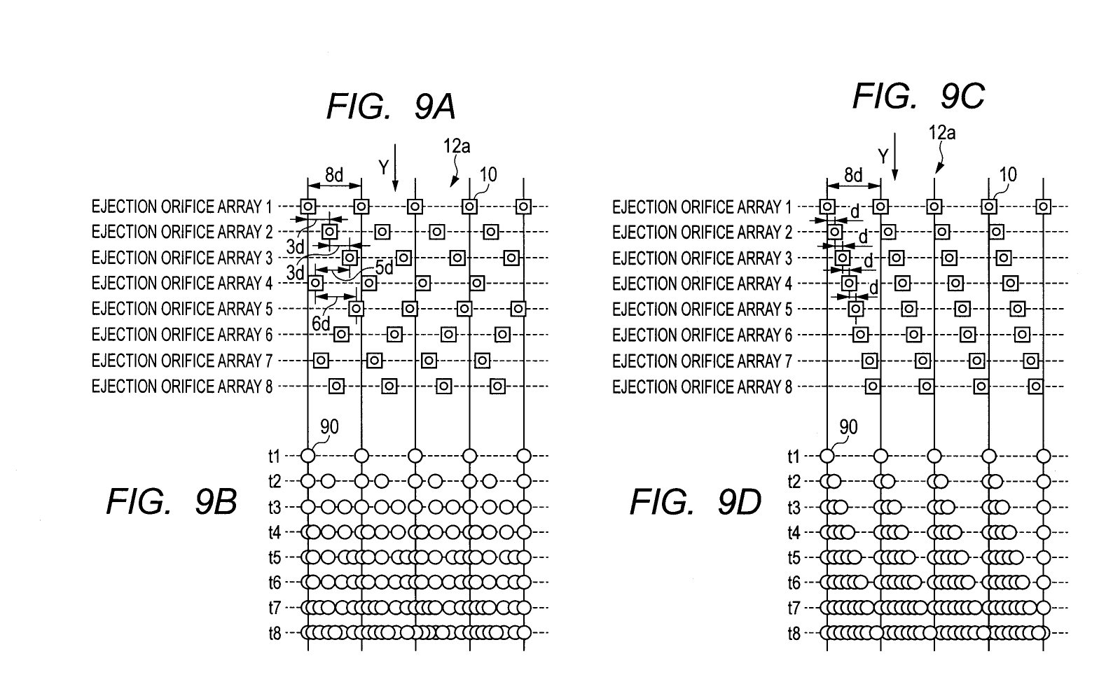

FIGS. 9A to 9D are schematic diagrams illustrating a liquid ejection head of a second embodiment of the invention. FIG. 9A is a layout diagram of the ejection orifices 10 of the liquid ejection head 12a of this embodiment. FIG. 9B is a diagram showing dots 90 of ink ejected from the ejection orifices 10 shown in FIG. 9A to the recording medium in accordance with the sequence of ejecting the ink. Further, FIG. 9C is a layout diagram of the ejection orifices 10 of the liquid ejection head 12 of the first embodiment. FIG. 9D is a diagram showing the dots 90 of the ink ejected from the ejection orifices 10 to the recording medium shown in FIG. 9C in accordance with the sequence of ejecting the ink.

In FIGS. 9A and 9C, the interval between the adjacent nozzles within the same array is 8d, and the dot interval formed by arranging eight arrays is thus d.

As shown in FIG. 9C, in the liquid ejection head 12 of the first embodiment, the centers of the ejection orifices 10 are deviated in the above-described first direction X in every ejection orifice array. For this reason, the length d of the deviation between two ejection orifice arrays which sequentially eject ink is constant. As a result, when ink is sequentially ejected from the respective ejection orifice arrays while the recording medium is transported in the transportation direction Y, the liquid ejection head 12 of the first embodiment sequentially forms the adjacent dots 90 as shown in FIG. 9D.

On the other hand, in the liquid ejection head 12a of this embodiment, as shown in FIG. 9A, the length of the deviation between two ejection orifice arrays which eject ink is different from the length of the deviation between the centers of different two ejection orifice arrays (so that they are not uniform). For example, the length of the deviation between the centers of the ejection orifices 31 present in the ejection orifice array 1 (the first ejection orifice array) and the ejection orifice array 2 (the second ejection orifice array) is 3d. On the contrary, the length of the deviation between the centers of the ejection orifices 10 in the ejection orifice array 3 and the ejection orifice array 4 (the fourth ejection orifice array) is 5d. For this reason, when the respective ejection orifice arrays sequentially eject ink while the recording medium is transported in the transportation direction Y, in the liquid ejection head 12a of this embodiment, as shown in FIG. 9B, the adjacent dots 90 are not continuously formed. Accordingly, in the liquid ejection head 12a of this embodiment, beading is not easily generated. Furthermore, in the manufacturing method disclosed in PTL 1, since the layered unit of the piezoelectric plate provided with the groove is cut in the direction perpendicular to the direction of the groove, the length of the deviation between the centers of the ejection orifices may not be changed every ejection orifice array as in this embodiment. Further, the beading mentioned herein indicates a phenomenon in which the concentration of ink is not constant because the next ink droplet is ejected before the first ejected ink droplet is absorbed to the recording medium, so that the ink droplets are mixed with each other to cause density unevenness.

### Third Embodiment

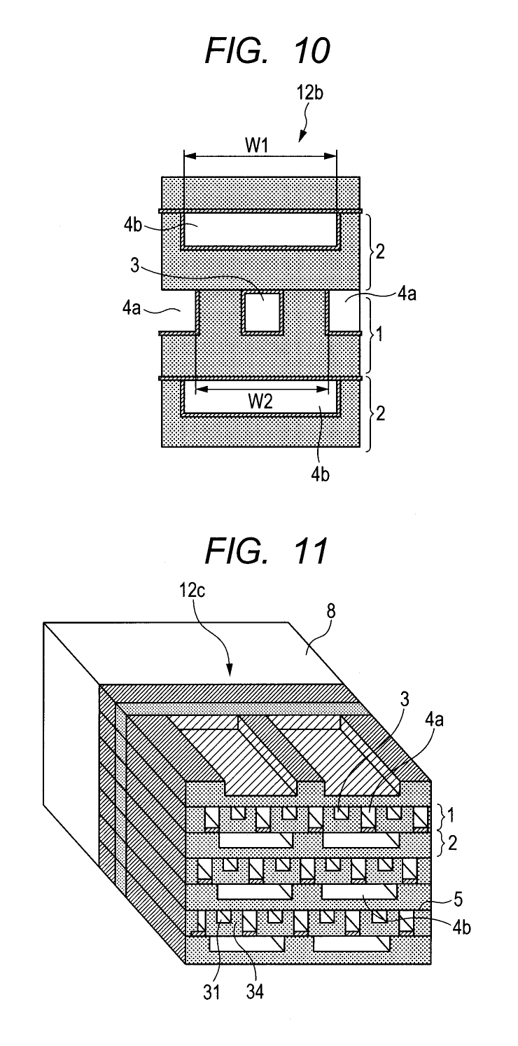

FIG. 10 is a front view showing the structure of a main part of a liquid ejection head of a third embodiment of the invention. In FIG. 10, the vicinity of the pressure chamber 3 of a liquid ejection head 12b of this embodiment is magnified. In the liquid ejection head 12b shown in FIG. 10, the shape of the recess portion 4b is different from that of the liquid ejection head 12 of the first embodiment. Specifically, in the liquid ejection head 12 of the first embodiment, as shown in FIG. 2A, the width of the recess portion 4b is narrower than the interval between the recess portions 4a. On the other hand, in the liquid ejection head 12b of this embodiment, the width W1 of the recess portion 4b is set to 0.48 mm, and the interval between the recess portions 4a with the pressure chamber 3 interposed therebetween is set to 0.36 mm. That is, the width W1 of the recess portion 4b is wider than the interval W2 between the recess portions 4a. For this reason, since the liquid ejection head 12b of this embodiment easily contracts the pressure chamber 3 compared to the liquid ejection head 12 of the first embodiment, the force of ejecting ink improves. Furthermore, since the liquid ejection head of this embodiment may be manufactured by widening the width of the groove 17b in the groove formation process described in the first embodiment, the manufacturing is not particularly difficult.

### Fourth Embodiment

FIG. 11 is a perspective view showing a liquid ejection head of a fourth embodiment of the invention. In a liquid ejection head 12c of this embodiment, the width of the recess portion 4b is much wider than that of the liquid ejection head 12b of the third embodiment. Specifically, in the liquid ejection head 12b of the third embodiment, one recess portion 4b is provided for each pressure chamber 3. On the other hand, in the liquid ejection head 12c of this embodiment, one recess portion 4b is provided for two pressure chambers 3. For this reason, since the liquid ejection head 12c of this embodiment can easily contract the pressure chamber 3 compared to the liquid ejection head 12b of the third embodiment, the force of ejecting ink further improves.

### Fifth Embodiment

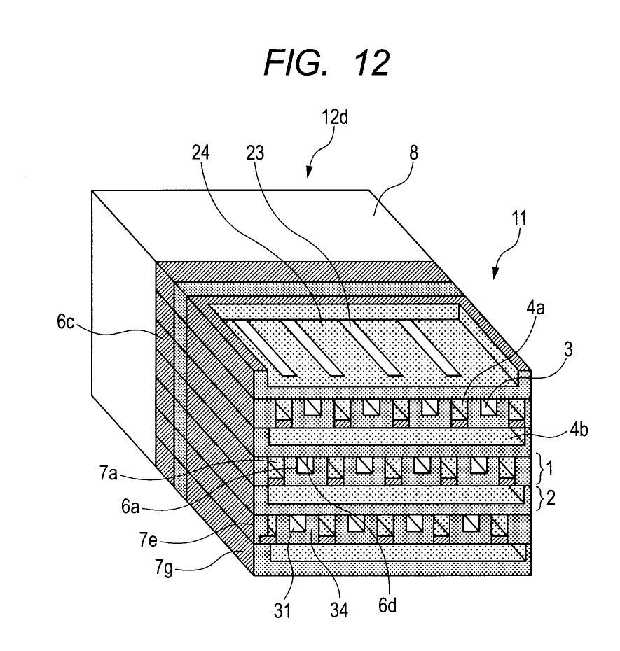

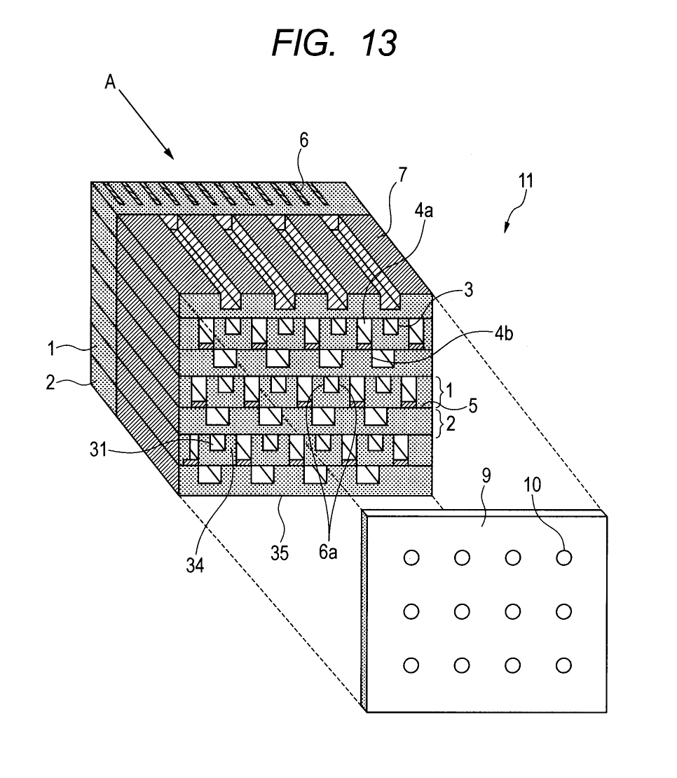

FIG. 12 is a perspective view showing the appearance of a liquid ejection head of a fifth embodiment of the invention. In a liquid ejection head 12d of this embodiment, the shape of the recess portion 4b is different from the shape of the liquid ejection head 12 of the first embodiment. Specifically, in the liquid ejection head 12 of the first embodiment, as shown in FIG. 2A, the plate 2 is provided with plural recess portions 4b. On the other hand, in the liquid ejection head 12d of this embodiment, the plural recess portions 4b are connected so as to form a single recess portion 4b with a wide width. Furthermore, in the liquid ejection head 12d of this embodiment, a slit 23 which penetrates the recess portion 4b and the recess portion 4a is provided. The slit 23 is provided so as to cause insulation cooling oil 24 injected from the recess portion 4b of the uppermost layer to fill up to the recess portion 4b of the lowermost layer. By circulating the insulation cooling oil 24 inside the recess portions 4a and 4b in this way, the liquid ejection head 12d can be cooled.

### Sixth Embodiment

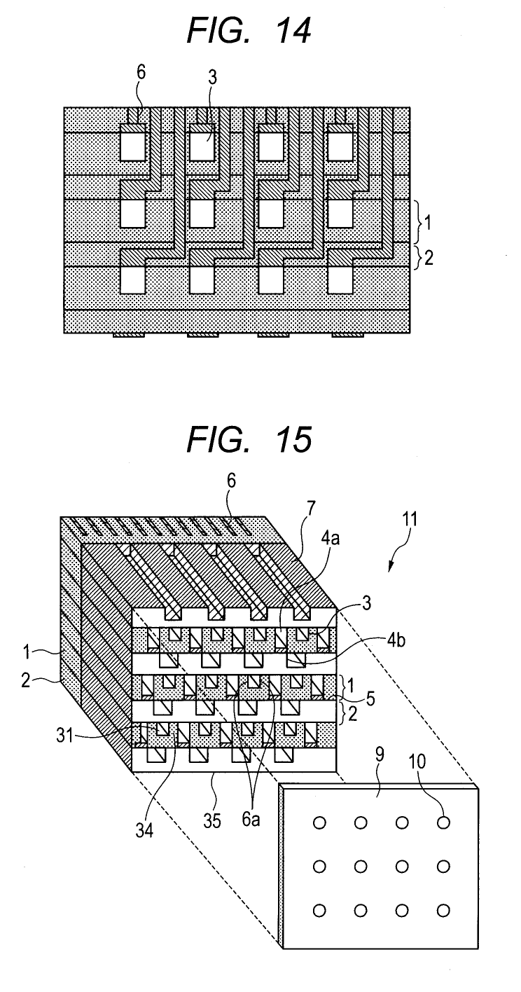

FIG. 13 is a perspective view showing an appearance of a liquid ejection head of a sixth embodiment of the invention, which is the same as that of the first embodiment except for the structure of the electrode wiring. The liquid ejection head of the invention shows a dot-on-demand type liquid ejection head which individually drives each pressure chamber. FIG. 14 is a perspective view when seen from A of FIG. 13. The electrode 6 and the first electrode 6a shown in FIG. 13 are electrically connected to each other so as to correspond to each other, thereby forming an individual electrode. The respective electrodes 6 extend upward from the inner wall of the pressure chamber 3 within the plane shown in FIG. 14, and are arranged on one side surface of the liquid ejection head 11 across the ridge line of the liquid ejection head 11 as shown in FIG. 13. A protective film is formed on the portion contacting ink in the electrode.

### Seventh Embodiment

FIG. 15 is a perspective view showing the appearance of a liquid ejection head of a seventh embodiment of the invention. The basic structure is the same as that of the sixth embodiment, but the material of the plate 2 is changed from the piezoelectric material to easy-machining ceramics. Since the top surface of the pressure chamber 3 is not the piezoelectric material, the driving surface is changed from four surfaces to three surfaces. However, since the easy-machining ceramics can be easily machined, be enough for mass production, and have high thermal conductivity, this is advantageous for preventing an increase in temperature of the head.

Here, although three surfaces of the pressure chamber are configured to be driven, the member around the pressure chamber may be other than the piezoelectric material. Further, even when the member is formed of the piezoelectric material, only two surfaces or one surface may be configured to be driven by providing a surface which does not form the electrode.
As above, according to the respective embodiments of the invention, since the interval between the pressure chambers is formed of the member and the recess portion, it is possible to increase the rigidity of each pressure chamber compared to the structure in which a space is interposed between the pressure chambers.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2010-288006, filed Dec. 24, 2010, and No. 2011-246454, filed Nov. 10, 2011 which are hereby incorporated by reference herein in their entirety.

1-9. (canceled)

10. A liquid ejection head comprising:
an ejection orifice for ejecting a liquid;
a pressure chamber for storing the liquid ejected from the ejection orifice, the pressure chamber having a first electrode on an inner side surface thereof concerning a supply direction of the liquid; and
a piezoelectric material which generates energy utilized for ejecting the liquid,
wherein concerning the supply direction, a side wall constituting the pressure chamber is formed of the piezoelectric material, and
wherein concerning a cross section of the liquid ejection head passing through the pressure chamber in a direction intersecting the supply direction, in each of a first direction and a second direction intersecting the first direction a plurality of openings having a second electrode on an inner side surface thereof are provided on both sides of the pressure chamber.

11. The liquid ejection head according to claim 10,
wherein in the cross section of the liquid ejection head, concerning the first direction the pressure chamber and the opening are alternately arranged, and concerning the second direction the pressure chamber and the opening are alternately arranged.

12. The liquid ejection head according to claim 10, wherein a first substrate in which a first groove forming part of the side wall of the pressure chamber and a second groove forming part of the opening are alternately formed in parallel and a second substrate in which a third groove forming part of the opening is formed in parallel are laminated.

13. The liquid ejection head according to claim 12, wherein at least one of the first substrate and the second substrate is a piezoelectric material.

14. The liquid ejection head according to claim 10, wherein the side wall constituting the pressure chamber is polarized in a direction of connecting the first electrode provided on the inner side surface of the pressure chamber and the second electrode provided on the inner side surface of the opening.

15. The liquid ejection head according to claim 10, further comprising on one end side of the pressure chamber a nozzle plate in which the ejection orifice is formed.

16. The liquid ejection head according to claim 11, wherein a plurality of the ejection orifices are arranged along the first direction, and a plurality of the ejection orifices are arranged obliquely with respect to a direction perpendicular to the first direction.

17. The liquid ejection head according to claim 10, wherein the plurality of openings are supplied with a liquid for cooling the liquid ejection head.

18. The liquid ejection head according to claim 10, wherein in the cross section of the liquid ejection head the pressure chamber has a rectangular cross sectional shape.

19. The liquid ejection head according to claim 10, wherein in the cross section of the liquid ejection head the opening has a rectangular cross sectional shape.

20. The liquid ejection head according to claim 10, wherein in the cross section of the liquid ejection head, concerning the pressure chamber and the opening alternately arranged in the first direction, the length of the opening in the second direction is longer than the length of the pressure chamber in the second direction.

21. The liquid ejection head according to claim 10, wherein in the cross section of the liquid ejection head, concerning the pressure chamber and the opening alternately arranged in the second direction, the length of the opening in the first direction is longer than the length of the pressure chamber in the first direction.

22. The liquid ejection head according to claim 10, wherein in the cross section of the liquid ejection head, concerning the pressure chamber and the opening alternately arranged in the first direction, the length of the opening in the first direction is shorter than the length of the pressure chamber in the first direction.

23. The liquid ejection head according to claim 10, wherein in the cross section of the liquid ejection head, concerning the pressure chamber and the opening alternately arranged in the second direction, the length of the opening in the second direction is shorter than the length of the pressure chamber in the second direction.

24. A method of manufacturing a liquid ejection head, comprising:
preparing a first substrate of a piezoelectric material comprising a first groove that has a first electrode in an inside thereof and extends in a predetermined direction and a plurality of second grooves that each have a second electrode in an inside thereof and extend on both sides of the first groove in parallel, and a second substrate comprising a third groove that has a second electrode in an inside thereof; and
bonding the first substrate with the second substrate.

25. The method of manufacturing the liquid ejection head according to claim 24, further comprising a step of bonding a third substrate comprising a fourth groove that has a second electrode in an inside thereof with a back surface to that surface of the first substrate on which the second substrate is bonded.

26. The method of manufacturing the liquid ejection head according to claim 25, wherein the second substrate and the third substrate are each formed of a piezoelectric material.

27. The method of manufacturing the liquid ejection head according to claim 24, wherein in the first substrate the first groove and the second groove are alternately formed plurally, and in the second substrate a plurality of the third grooves are formed in parallel.

28. The method of manufacturing the liquid ejection head according to claim 24, further comprising a step of subjecting each of the first substrate and the second substrate to a polarization treatment process prior to the bonding step
